(19) United States
(12) Patent Application Publication
(10) Pub. No.: US 2026/0348312 A1
(43) Pub. Date: Nov. 5, 2026

(54) MUFFLER WITH HELMHOLTZ RESONATOR FOR VEHICLE EXHAUST SYSTEM

(71) Applicant: BOMBARDIER RECREATIONAL PRODUCTS INC., Valcourt (CA)

(72) Inventor: Karim MASMOUDI, Sherbrooke (CA)

(21) Appl. No.: 19/655,774

(22) Filed: Apr. 23, 2026

Related U.S. Application Data
(60) Provisional application No. 63/800,115, filed on May 5, 2025.

(51) Int. Cl. F01N 1/02; G10K 11/16

(52) U.S. Cl. CPC F01N 1/023; G10K 11/161; F01N 2470/04; F01N 2490/15

(57) ABSTRACT

A muffler for a vehicle exhaust system includes a shell with an inlet and an outlet, and a wall within the shell. A chamber is defined on one side of the wall, allowing fluid communication between the inlet and outlet. On the opposite side of the wall, a Helmholtz resonator is defined within the shell. A perforated baffle fluidly communicates the chamber with a volume of the Helmholtz resonator. This configuration aims to enhance sound attenuation by utilizing the Helmholtz resonator to target specific frequencies.

### CROSS-REFERENCE

The present application claims priority to United States Provisional Patent Application No. 63/800,115, filed May 5, 2025, the entirety of which is incorporated herein by reference.

### TECHNICAL FIELD

The present technology relates to mufflers having a Helmholtz resonator for vehicle exhaust systems.

### BACKGROUND

In the field of vehicle exhaust systems, various approaches have been developed to reduce noise emissions and improve acoustic performance. Traditional mufflers often employ a series of baffles and chambers to attenuate sound waves generated by the engine. These designs typically rely on the principle of destructive interference, where sound waves are reflected and redirected within the muffler to cancel out certain frequencies and/or on the principle of mass-spring systems. While effective to some extent, these conventional mufflers can be bulky and may not provide optimal noise reduction across a wide range of frequencies.

Another approach involves the use of Helmholtz resonators, which are specifically tuned to target and attenuate specific frequencies of sound. Helmholtz resonators are typically integrated into the exhaust system as separate components or as part of the muffler design. These resonators work by creating a neck and a cavity that resonate at a particular frequency, thereby reducing the amplitude of acoustic waves at that frequency. However, integrating Helmholtz resonators into existing muffler designs can be challenging due to space constraints and the complexity of tuning the resonator to the desired frequency.

However, these approaches fail to provide a comprehensive solution that combines the features described in this disclosure.

### SUMMARY

It is an object of the present technology to ameliorate at least some of the inconveniences present in the prior art.

In some aspects, the techniques described herein relate to a muffler for an exhaust system of a vehicle, the muffler including: a shell defining an inlet and an outlet; a wall disposed in the shell; a chamber defined in the shell on a first side of the wall, the inlet and the outlet fluidly communicating with the chamber; a Helmholtz resonator defined in the shell on a second side of the wall; and a perforated baffle fluidly communicating the chamber with a volume of the Helmholtz resonator.

In some aspects, the techniques described herein relate to a muffler, wherein the Helmholtz resonator is configured to target a frequency range of 180 Hz to 250 Hz.

In some aspects, the techniques described herein relate to a muffler, wherein the chamber fluidly communicates with the Helmholtz resonator only via perforations defined in the perforated baffle.

In some aspects, the techniques described herein relate to a muffler, wherein the perforations have a diameter of 3.5 mm.

In some aspects, the techniques described herein relate to a muffler, wherein: the wall defines a neck of the Helmholtz resonator; and the perforated baffle is disposed in the neck.

In some aspects, the techniques described herein relate to a muffler, wherein: the wall is a first wall; the chamber is a first chamber; the muffler further includes: a second wall disposed in the shell, the second wall defining a passage; and a second chamber defined in the shell on a first side of the second wall; the first chamber being defined between the first side of the first wall and a second side of the second wall; the inlet fluidly communicates with the second chamber; and the passage fluidly communicates the second chamber with the first chamber.

In some aspects, the techniques described herein relate to a muffler, further including: an inlet pipe disposed in the inlet, the inlet pipe being configured to fluidly communicate an engine of the vehicle with the second chamber; an intermediate pipe disposed in the passage, the intermediate pipe fluidly communicating the second chamber with the first chamber; and an outlet pipe disposed in the outlet, the outlet pipe being configured to fluidly communicate the first chamber with an environment of the muffler.

In some aspects, the techniques described herein relate to a muffler, wherein: the passage is a first passage; the first wall defines a second passage; and the outlet pipe is disposed in the outlet and in the second passage, and extends through the Helmholtz resonator.

In some aspects, the techniques described herein relate to a muffler, wherein: the inlet is defined in an inlet end of the shell; the outlet is defined in an outlet end of the shell; the second chamber is disposed between the second wall and the inlet end; and the Helmholtz resonator is disposed between the first wall and the outlet end.

In some aspects, the techniques described herein relate to a muffler, wherein the second wall includes: a first partition on the first side of the second wall; a second partition on the second side of the second wall, the second partition defining a plurality of perforations fluidly communicating the first chamber with a space defined between the first partition and the second partition; and sound-insulating wool disposed in the space.

In some aspects, the techniques described herein relate to a muffler for an exhaust system of a vehicle, the muffler including: a shell defining an inlet and an outlet; a first acoustic device disposed in the shell, the first acoustic device being configured to attenuate sound emissions in a first targeted frequency range; and a second acoustic device disposed in the shell, the second acoustic device being configured to attenuate sound emissions in a second targeted frequency range, the second targeted frequency range being higher than the first targeted frequency range, and the first targeted frequency range and the second targeted frequency range are consecutive ranges.

In some aspects, the techniques described herein relate to a muffler, wherein: the first targeted frequency range is from 180 Hz to 250 Hz; and the second targeted frequency range is from 250 Hz to 320 Hz.

In some aspects, the techniques described herein relate to a muffler, wherein acoustic interaction of the second acoustic device with the first acoustic device reduces an attenuation of sound emission by the first acoustic device in the first targeted frequency range compared to an attenuation of sound emission by the first acoustic device in the first targeted frequency range with the second acoustic device being omitted from the muffler.

In some aspects, the techniques described herein relate to a muffler, wherein the second acoustic device is configured to attenuate sound emissions of a single order in the second targeted frequency range by at least 5dB.

In some aspects, the techniques described herein relate to a muffler, wherein the single order is an order of 3.0.

In some aspects, the techniques described herein relate to a muffler, wherein the first acoustic device is a Helmholtz resonator.

In some aspects, the techniques described herein relate to a muffler, further including: a wall disposed in the shell; and a chamber defined in the shell on a first side of the wall, the inlet and the outlet fluidly communicating with the chamber; wherein: the Helmholtz resonator is defined in the shell on a second side of the wall; the second acoustic device is a perforated baffle disposed in the wall; and the perforated baffle fluidly communicates the chamber with the Helmholtz resonator.

In some aspects, the techniques described herein relate to a muffler, wherein the chamber fluidly communicates with the Helmholtz resonator only via perforations defined in the perforated baffle.

In some aspects, the techniques described herein relate to a muffler, wherein: the wall defines a neck of the Helmholtz resonator; and the perforated baffle is disposed in the neck.

In some aspects, the techniques described herein relate to a muffler, wherein: the wall is a first wall; the chamber is a first chamber; the muffler further includes: a second wall disposed in the shell, the second wall defining a passage; and a second chamber defined in the shell on a first side of the second wall; the first chamber being defined between the first side of the first wall and a second side of the second wall; the inlet fluidly communicates with the second chamber; and the passage fluidly communicates the second chamber with the first chamber.

In some aspects, the techniques described herein relate to a muffler, wherein the perforated baffle is disposed in the wall.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

For purposes of the present application, terms related to spatial orientation when referring to a vehicle and components in relation to the vehicle, such as “vertical”, “horizontal”, “forwardly”, “rearwardly”, “left”, “right”, “above” and “below”, are as they would be understood by a driver of the vehicle sitting thereon in an upright driving position, with the vehicle steered straight-ahead and being at rest on flat, level ground.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of embodiments of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view taken from a front, left side of a side-by-side off-road vehicle;

FIG. 2 is a right side elevation view of the vehicle of FIG. 1, with body panels, a cargo box, seats, and other components inside a passenger area being removed;

FIG. 3 is a perspective view taken from a rear, left side of a muffler of the vehicle of FIG. 1;

FIG. 4 is a perspective view taken from a rear, right side of the muffler of FIG. 3;

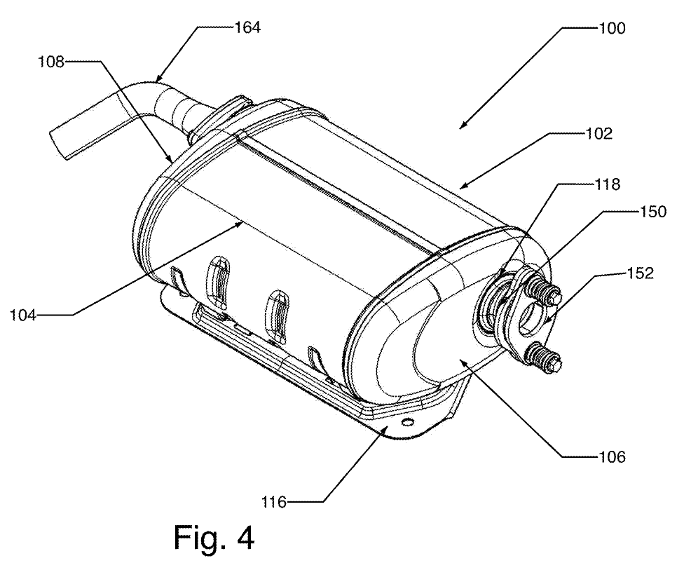

FIG. 5 is a front elevation view of the muffler of FIG. 3;

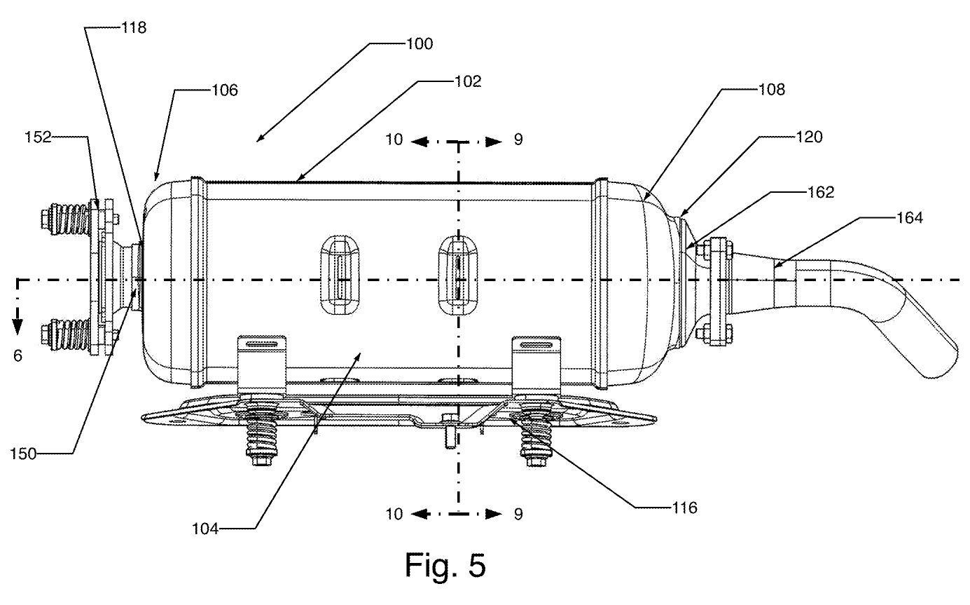

FIG. 6 is a cross-section of the muffler of FIG. 3 taken through line 6-6 of FIG. 5;

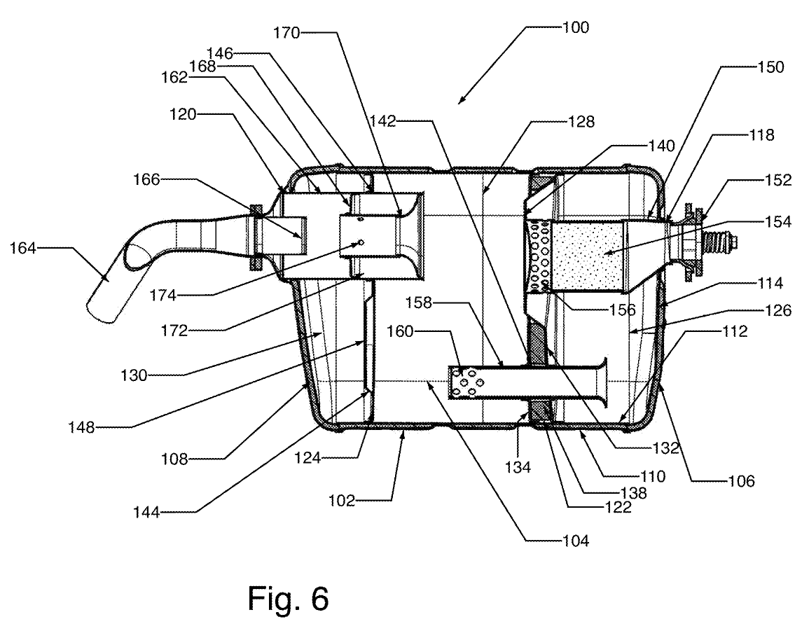

FIG. 7 is a perspective view taken from a rear, left side of the cross-sectional view of the muffler of FIG. 6;

FIG. 8 is a perspective view taken from a rear, left side of the cross-sectional view of the muffler of FIG. 6;

FIG. 9 is a cross-section of the muffler of FIG. 3 taken through line 9-9 of FIG. 5;

FIG. 10 is a cross-section of the muffler of FIG. 3 taken through line 10-10 of FIG. 5; and

FIG. 11 illustrates graphs of sound pressure level over engine speed for different orders, with the solid lines corresponding to data for the muffler of FIG. 3 and the stippled lines corresponding to data for the muffler of FIG. 3 without a perforated baffle.

### DETAILED DESCRIPTION

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of "including", "comprising", or "having", "containing", "involving" and variations thereof herein, is meant to encompass the items listed thereafter as well as, optionally, additional items. In the following description, the same numerical references refer to similar elements.

The present technology will be described with reference to a side-by-side vehicle 10. It is contemplated that the present technology could be used in other types of vehicles having an exhaust system such as an off-road all-terrain vehicle (ATV), a personal watercraft, a boat having an inboard engine, and an on-road vehicle such as a car or truck.

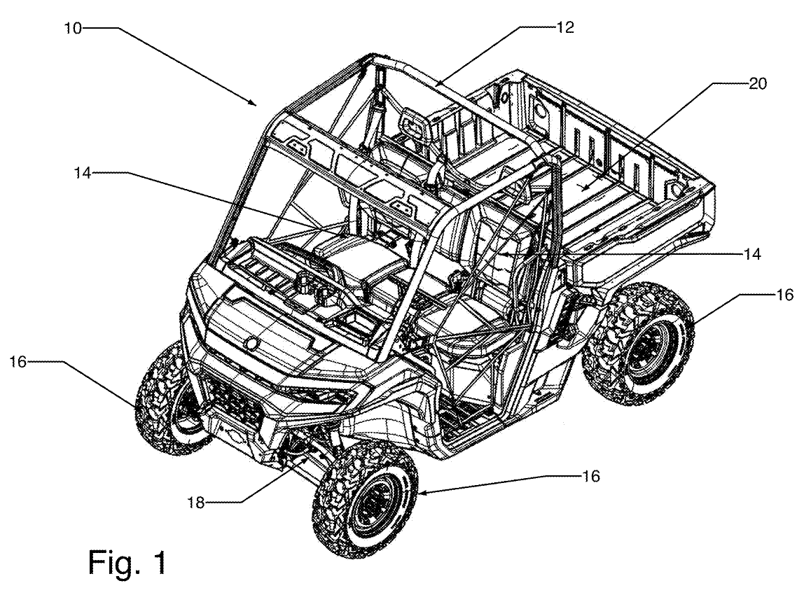

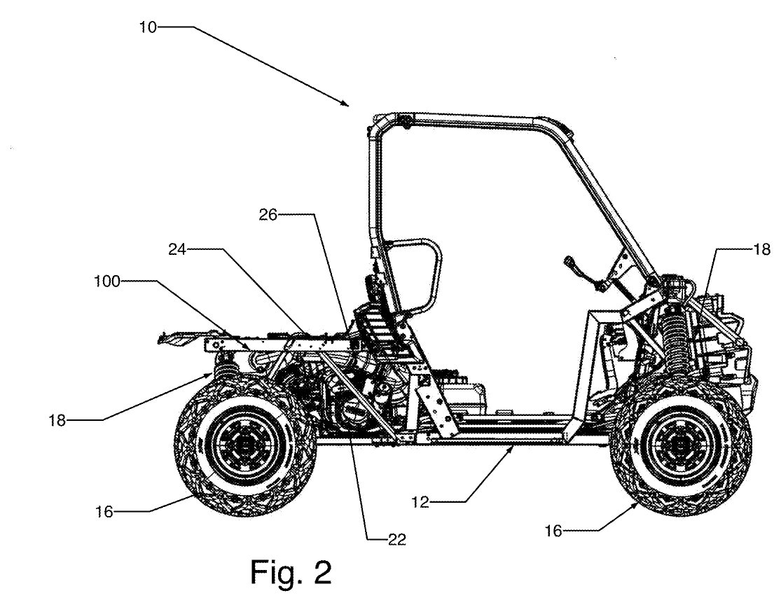

With reference to FIGS. 1 and 2, the side-by-side vehicle 10 has a frame 12. Two seats 14 are disposed side-by-side on the frame 12. Four wheels 16 are connected to the frame 12 via suspensions 18. A cargo box 20 is connected to the frame 12 behind the two seats 14. The four wheels 16 are driven by an internal combustion engine 22. The internal combustion engine 22 is connected to the frame 12 behind the two seats 14 and under the cargo box 20. In the present embodiment, the internal combustion engine 22 is a four-stroke internal combustion engine, but other types of engines, such as two-stroke engines, are contemplated.

The internal combustion engine 22 is fluidly connected to an exhaust system 24. The exhaust system 24 includes a muffler 100 and an exhaust conduit 26 fluidly connecting the muffler 100 to exhaust outlets (not shown) of the internal combustion engine 22. In the present embodiment, the exhaust outlets of the internal combustion engine 22 are positioned on the front of the internal combustion engine 22, but it is contemplated that the exhaust outlets could be disposed elsewhere. The exhaust conduit 26 is formed from a plurality of exhaust pipes.

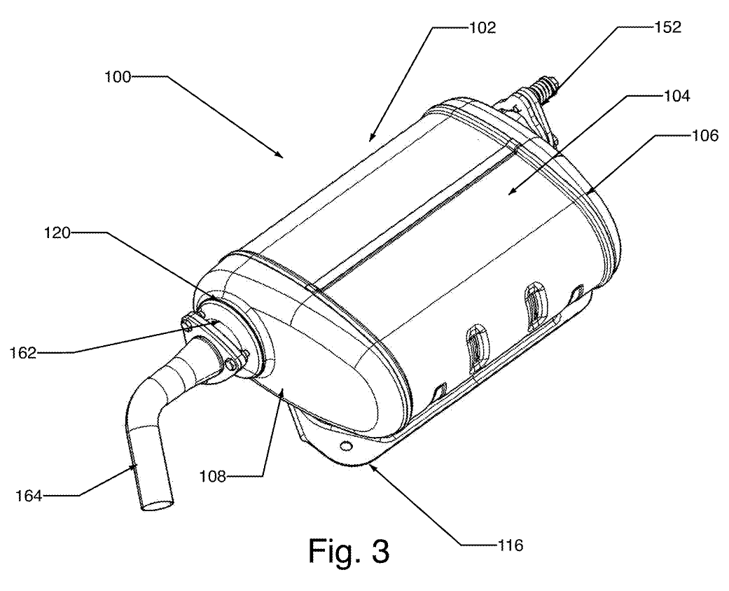

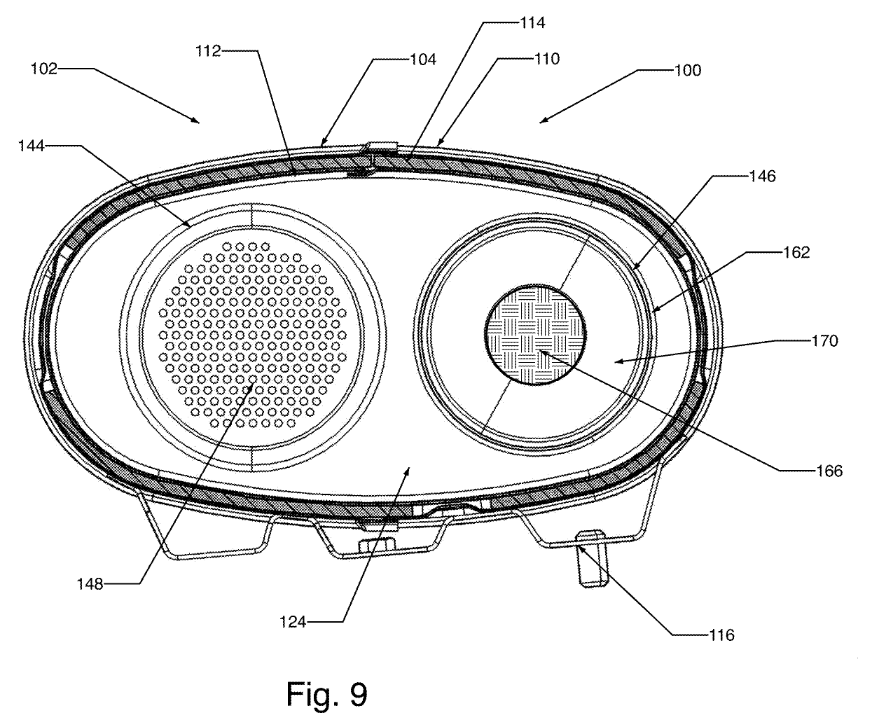

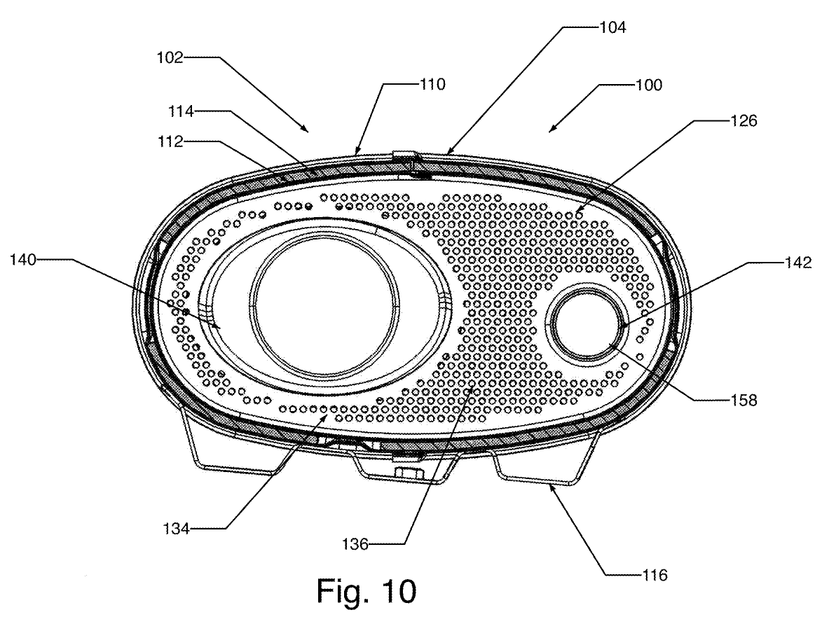

Turning now to FIGS. 3 - 10, the muffler 100 will now be described in more detail. The muffler 100 has a shell 102. The shell 102 has a shell body 104, an inlet end 106 and an outlet end 108. As can be seen in FIGS. 9 and 10, in this embodiment, the shell body 104 has a generally oval shape. The shell body 104, the inlet end 106, and the outlet end 108 define an outer casing 110, an inner casing 112, and thermal and/or sound insulating material 114 (e.g., an insulating wool) provided between the outer casing 110 and the inner casing 112. A spring-loaded support 116 is connected to a bottom of the shell 102. The support 116 connects the muffler 100 to the frame 12 and helps reduce the transmission of vibrations from the frame 12 to the muffler 100.

The inlet end 106 defines an inlet 118 and the outlet end 108 defines an outlet 120. Although the inlet 118 and the outlet 120 are defined in the ends 106, 108 in the present embodiment, it is contemplated that one or both of the inlet 118 and the outlet 120 could be defined on a side, a top, or a bottom of the shell 102.

A wall 122 is disposed inside the shell 102. Another wall 124 is disposed inside the shell 102. The walls 122, 124 separate the inner volume of the shell 102 into three sections. A chamber 126 is defined in the shell 102 between the inlet end 106 and a side of the wall 122 facing the inlet end 106. A chamber 128 is defined in the shell 102 between sides of the walls 122, 124 that face each other. A Helmholtz resonator 130 is defined in the shell 102 between the outlet end 108 and a side of the wall 124 facing the outlet end 108. The inlet 118 fluidly communicates with the chamber 126. The chamber 126 fluidly communicates with the chamber 128 as will be described below. The chamber 128 fluidly communicates with the outlet 120 as will be described below. The chamber 128 also fluidly communicates with the Helmholtz resonator 130. It is contemplated that in some embodiments the wall 122 could be omitted such that the muffler 100 would have a single chamber and the Helmholtz resonator 130. It is also contemplated that in some embodiments, more walls could be provided in the shell 102 such that the muffler 100 would have more than two chambers 126, 128.

The wall 122 has a partition 132 on an inlet end 106 facing side of the wall 122, and a partition 134 on a wall 124 facing side of the wall 122. As best seen in FIG. 10, the partition 134 defines a plurality of perforations 136. The perforations 136 fluidly communicate the chamber 128 with a space defined between the partitions 132, 134. The wall 122 also has sound insulating wool 138 disposed in the space between the partition 132 and the partition 134. The partition 132 has a recess 140 that extends through the partition 134 via an aperture defined in the partition 134. The wall 122 defines a passage 142 fluidly communicating the chamber 126 with the chamber 128.

In this embodiment, the wall 124 has a recess that defines a neck 144 of the Helmholtz resonator 130. The wall also defines a passage 146. A perforated baffle 148 fluidly communicates the chamber 128 with a volume of the Helmholtz resonator 130. In this embodiment, more specifically, the perforated baffle 148 is disposed in the wall 124. More specifically, the perforated baffle 148 is disposed in the neck 144. The chamber 128 fluidly communicates with the Helmholtz resonator 130 only via the perforations defined in the perforated baffle 148. The perforations defined in the perforated baffle 148 are the only features of the muffler 100 that permit the passage of gas in and out of the volume of the Helmholtz resonator 130. In the present embodiment, the perforated baffle 148 is formed from the metal sheet forming the wall 124, but it is contemplated that the perforated baffle 148 could be a discrete part that is then connected to the wall 124. In other embodiments, the neck 144 may be formed of a pipe defining the passage 146 through the wall 124 and the perforated baffle may be affixed to the pipe. The Helmholtz resonator 130 and the perforated baffle 148 will be described in more detail below.

An inlet pipe 150 is disposed in the inlet 118. The inlet pipe 150 fluidly communicates the internal combustion engine 22 with the chamber 126 via the exhaust conduit 26. A spring-loaded connector 152 is connected to an upstream end of the inlet pipe 150. The spring-loaded connector 152 connects the inlet pipe 150 to the exhaust conduit 26 and helps reduce the transmission of vibrations from the exhaust conduit 26 to the muffler 100. A downstream end of the inlet pipe 150 is received in the recess 140 and abuts the wall 122. A catalyst 154 is provided inside the inlet pipe 150. Apertures 156 defined in a circumference of the inlet pipe 150 downstream of the catalyst 154 fluidly communicate the inlet pipe 150 with the chamber 126.

An intermediate pipe 158 is disposed in the passage 142. The intermediate pipe 158 fluidly communicates the chamber 126 with the chamber 128. The intermediate pipe 158 has a flared upstream end and a closed downstream end. Apertures 160 defined in a circumference of the intermediate pipe 158 fluidly communicate the intermediate pipe 158 with the chamber 128.

An outlet pipe 162 is disposed in the outlet 120 and the passage 146 and extends through the Helmholtz resonator 130. A tail pipe 164 is connected to and extends partially inside the outlet pipe 162. The outlet pipe 162 fluidly communicates the chamber 128 with an environment of the muffler 100 via the tail pipe 164. A flame arrestor 166 is provided at an upstream end of the tail pipe 164. A wall 168 is disposed in the outlet pipe 162. A pipe 170 having a flared upstream end is connected to the upstream end of the outlet pipe 162, extends in the outlet pipe 162, and passes through the wall 168. A resonator 172 (e.g., a concentric Helmholtz resonator) is defined between the outlet pipe 162, the wall 168, and the pipe 170. Apertures 174 defined in the resonator 172 fluidly communicate the pipe 170 with the resonator 172.

During operation, exhaust gases flow from the internal combustion engine 22 to the exhaust conduit 26, and from the exhaust conduit 26 to the muffler 100. More specifically, from the exhaust conduit 26 the exhaust gases flow in the inlet pipe 150. In the inlet pipe 150, the exhaust gases flow through the catalyst 154 and then into the chamber 126. From the chamber 126, the exhaust gases flow to the chamber 128 via the intermediate pipe 158. Some of the exhaust gases in the chamber 128 may flow to the Helmholtz resonator 130 via the perforated baffle 148, although an average flow through the Helmholtz resonator 130, in this embodiment, is nil. Some of the exhaust gases in the chamber 128 may flow, via perforations 136, in the space defined between the partitions 132, 134, although an average flow through the space defined between the partitions 132, 134, in this embodiment, is nil. The exhaust gases in the chamber 128 flow in the pipe 170. From the pipe 170, exhaust gases flow into the outlet pipe 162, some into the resonator 172, but most into the portion of the outlet pipe 162 downstream of the wall 168. From the outlet pipe 162, exhaust gases flow through the flame arrestor 166 into the tail pipe 164. From the tail pipe 164, the exhaust gases are released into the atmosphere.

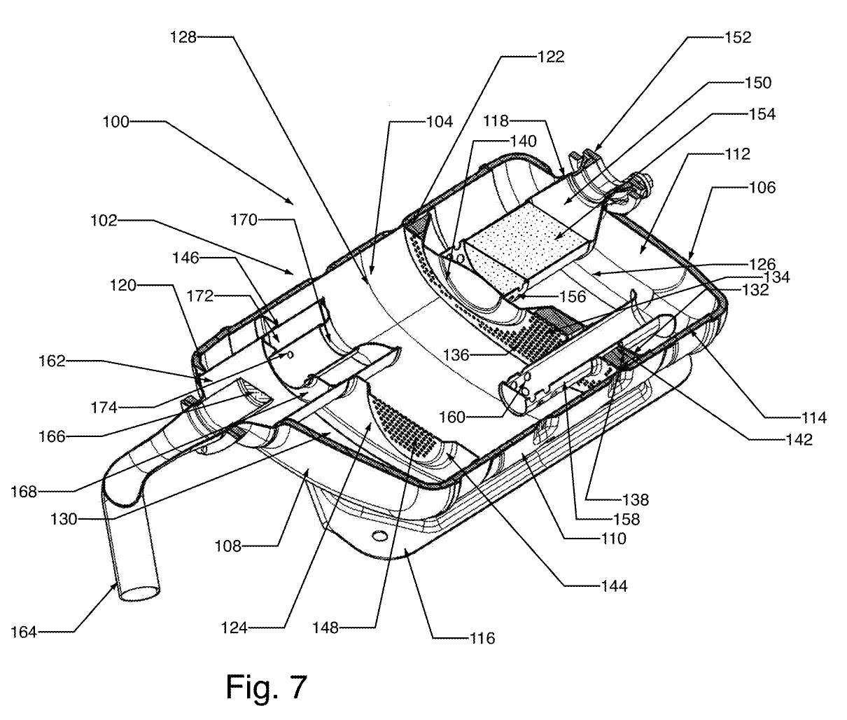

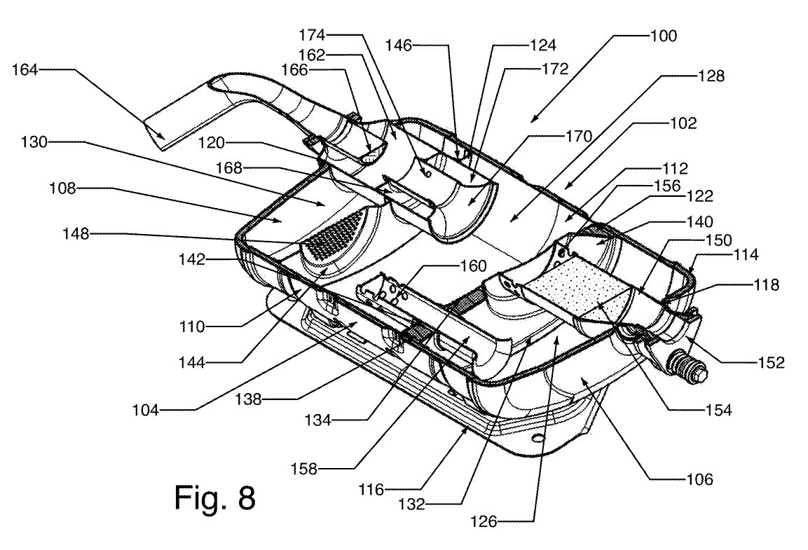

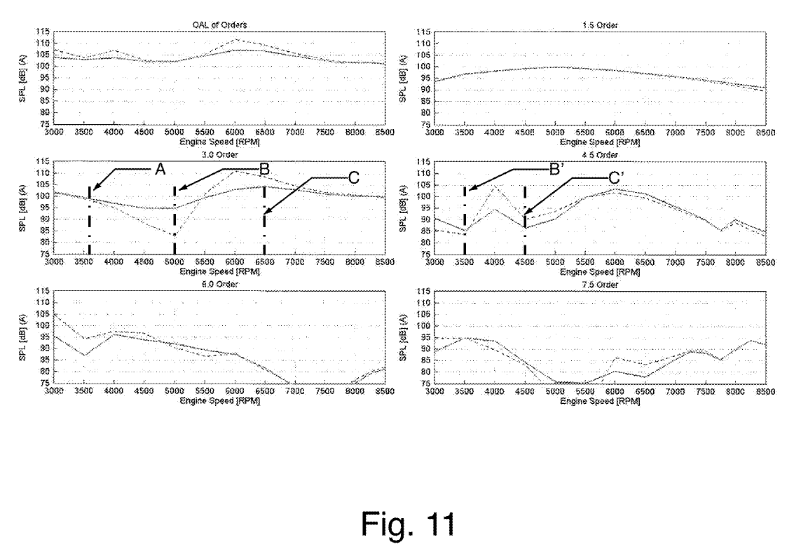

Turning now to FIGS. 7-9 and 11, the Helmholtz resonator 130 and the perforated baffle 148 will be described in more detail. As previously mentioned, FIG. 11 illustrates graphs of sound pressure level over engine speed for different orders, with the solid lines corresponding to data for the muffler 100 and the stippled lines corresponding to data for a muffler without a perforated baffle (i.e., a single opening in place of the baffle) but otherwise identical to the muffler 100. More specifically, in FIG. 11, the graphs illustrate sound pressure level over engine speed for the overall level (OAL) of orders, 1.5 order, 3.0 order, 4.5 order, 6.0 order, and 7.5 order. The orders may be referred to as engine orders and are defined by the engine type, the engine speed, and the number of cylinders. For instance, in this embodiment, the engine is a four-stroke engine comprising three cylinders. For the specific orders, the sound frequency in Hertz (Hz) can be calculated by multiplying the engine speed by the order and dividing the result by sixty. For example, for the 3.0 order, at a speed of 6000 RPM, the frequency is 300 Hz (i.e., 6000 x 3 / 60).

The Helmholtz resonator 130 is tuned to attenuate sound emissions in a first targeted frequency range at a pre-determined temperature. In the present embodiment, the first targeted frequency range is illustrated between lines A and B in FIG. 11 and is of 180 Hz to 250 Hz at a temperature between 500ºC and 580ºC (e.g., about 540 ºC). In other embodiments, it is contemplated that the first targeted frequency range may be 250 Hz to 325 Hz, 325 Hz to 400 Hz, 400 Hz to 500 Hz, and 500 Hz to 600 Hz. The tuning may comprise setting a volume of the Helmholtz resonator 130 and setting a length and a diameter of the neck 144. In this embodiment, the volume of the Helmholtz resonator 130 is between 0.002m³ and 0.003m³ and is more specifically about 0.0025m³; the length of the neck 144 is between 8mm and 9mm and is more specifically about 8.65 mm; and the diameter of the neck 144 is between 80mm and 100mm and is more specifically about 97mm.

The perforated baffle 148 is configured to attenuate sound emissions in a second targeted frequency range, thanks to nonlinear effects occurring with high-amplitude oscillations through perforations and/or other acoustic phenomena. In the present embodiment, the perforated baffle 148 is configured to attenuate sound emissions in a frequency range of 250 Hz to 320 Hz (i.e., between lines B and C in FIG. 11). In other embodiments, it is contemplated that the second targeted frequency range is higher than the first targeted frequency range and may be 325 Hz to 400 Hz, 400 Hz to 500 Hz, 500 Hz to 600 Hz, and 600 Hz to 700 Hz. The first frequency range for which the Helmholtz resonator 130 is tuned and the second frequency range for which the perforated baffle 148 attenuates sound emissions during use are consecutive frequency ranges. Consecutive ranges are ranges that follow one another in sequence without any gaps between them. In the present embodiment, the perforated baffle 148 has 202 perforations, each having a diameter of 3.5mm. It is contemplated that the perforated baffle 148 could have more or less perforations and that the perforations could have a different diameter. A total surface area of the perforations is between 20% and 30% of a planar surface area of the neck 144 (i.e., a surface area of a circle having the diameter of the neck 144). More specifically, the total surface area of the perforations is about 25% of the planar surface area of the neck 144. In an embodiment where the perforated baffle 148 has a diameter of 97mm and 202 perforations having a diameter of 3.5mm, the total surface area of the perforations is 26.3% of the planar surface area of the neck 144.

As best seen in the graph of the 3.0 order of FIG. 11, in the muffler 100 without the perforated baffle 148 (stippled line), the Helmholtz resonator provides substantial attenuation of sound emissions in the first targeted frequency range (up to 5000 RPM (250 Hz, line B)), but the level of attenuation quickly degrades in the consecutive, second targeted frequency range of frequencies (between lines B and C). In some embodiments, the Helmholtz resonator may have the drawback of substantially amplifying sound emissions in the second targeted range of frequencies, thus creating a sound emission peak. By adding the perforated baffle 148, the overall sound emissions in the second targeted range of frequencies (between 5000 RPM (250 Hz, line B) and 6500 RPM (320 Hz, line C)) are attenuated (solid line). At some frequencies in the second targeted range of frequencies, the sound emissions compared to the muffler 100 without the perforated baffle 148 are at least 5dB, and up to about 8dB. These advantages are also present in other orders in the corresponding frequency ranges, for example, at the 4.5 order, for a first targeted frequency range occurring between approximately 2400 RPM and approximately 3500 RPM (line B’ in FIG. 11), and a second targeted frequency range occurring between approximately 3500 RPM (line B’) and approximately 4500 RPM (line C’ in FIG. 11). As can also be seen by comparing the stippled line to the solid line in the graph of the 3.0 order, acoustic interaction of the perforated baffle 148 with the Helmholtz resonator 130 reduces the attenuation of sound emission by the Helmholtz resonator 130 in the first targeted frequency range compared to an attenuation of sound emission by the Helmholtz resonator 130 in the first targeted frequency range with the perforated baffle 148 being omitted from the muffler 100 (i.e., the muffler 100 is louder between lines A and B with the perforated baffle 148 than without the perforated baffle 148). However, the muffler 100 with the perforated baffle 148 (solid line) has a more even sound attenuation across all frequencies and a lower peak (i.e., maximum level) of overall sound across all frequencies, which results in a more even sound, which is more pleasant to the ears of the driver, passengers, and bystanders.

The Helmholtz resonator 130 and the perforated baffle 148 are two examples of first and second acoustic devices that could be provided in a muffler and acoustically interact with each other to provide sound attenuation. Other embodiments of first and second acoustic devices to be provided in a shell of a muffler are contemplated. For such embodiments of first and second acoustic devices, the first acoustic device is configured to attenuate sound emissions in a first targeted frequency range, the second acoustic device is configured to attenuate sound emissions in a second targeted frequency range. The second targeted frequency range is higher than the first targeted frequency range. The first targeted frequency range and the second targeted frequency range are consecutive ranges. In some versions of such embodiments of first and second acoustic devices, acoustic interaction of the second acoustic device with the first acoustic device reduces an attenuation of sound emission by the first acoustic device in the first targeted frequency range compared to an attenuation of sound emission by the first acoustic device in the first targeted frequency range with the second acoustic device being omitted from the muffler.

Modifications and improvements to the above-described embodiments of the present invention may become apparent to those skilled in the art. The foregoing description is intended to be exemplary rather than limiting. The scope of the present technology is therefore intended to be limited solely by the appended claims.

What is claimed is:

1. A muffler for an exhaust system of a vehicle, the muffler comprising:
a shell defining an inlet and an outlet;
a wall disposed in the shell;
a chamber defined in the shell on a first side of the wall,
the inlet and the outlet fluidly communicating with the chamber;
a Helmholtz resonator defined in the shell on a second side of the wall; and
a perforated baffle fluidly communicating the chamber with a volume of the Helmholtz resonator.

2. The muffler of claim 1, wherein the Helmholtz resonator is configured to target a frequency range of 180 Hz to 250 Hz.

3. The muffler of claim 1, wherein the chamber fluidly communicates with the Helmholtz resonator only via perforations defined in the perforated baffle.

4. The muffler of claim 3, wherein the perforations have a diameter of 3.5 mm.

5. The muffler of claim 1, wherein:
the wall defines a neck of the Helmholtz resonator; and
the perforated baffle is disposed in the neck.

6. The muffler of claim 1, wherein:
the wall is a first wall;
the chamber is a first chamber;
the muffler further comprises:
a second wall disposed in the shell, the second wall defining a passage; and
a second chamber defined in the shell on a first side of the second wall;
the first chamber being defined between the first side of the first wall and a second side of the second wall;
the inlet fluidly communicates with the second chamber; and
the passage fluidly communicates the second chamber with the first chamber.

7. The muffler of claim 6, further comprising:
an inlet pipe disposed in the inlet, the inlet pipe being configured to fluidly communicate an engine of the vehicle with the second chamber;
an intermediate pipe disposed in the passage, the intermediate pipe fluidly communicating the second chamber with the first chamber; and
an outlet pipe disposed in the outlet, the outlet pipe being configured to fluidly communicate the first chamber with an environment of the muffler.

8. The muffler of claim 7, wherein:
the passage is a first passage;
the first wall defines a second passage; and
the outlet pipe is disposed in the outlet and in the second passage, and extends through the Helmholtz resonator.

9. The muffler of claim 6, wherein:
the inlet is defined in an inlet end of the shell;
the outlet is defined in an outlet end of the shell;
the second chamber is disposed between the second wall and the inlet end; and
the Helmholtz resonator is disposed between the first wall and the outlet end.

10. The muffler of claim 6, wherein the second wall comprises:
a first partition on the first side of the second wall;
a second partition on the second side of the second wall, the second partition defining a plurality of perforations fluidly communicating the first chamber with a space defined between the first partition and the second partition; and
sound-insulating wool disposed in the space.

11. A muffler for an exhaust system of a vehicle, the muffler comprising:
a shell defining an inlet and an outlet;
a first acoustic device disposed in the shell, the first acoustic device being configured to attenuate sound emissions in a first targeted frequency range; and
a second acoustic device disposed in the shell, the second acoustic device being configured to attenuate sound emissions in a second targeted frequency range, the second targeted frequency range being higher than the first targeted frequency range, and the first targeted frequency range and the second targeted frequency range are consecutive ranges.

12. The muffler of claim 11, wherein:
the first targeted frequency range is from 180 Hz to 250 Hz; and
the second targeted frequency range is from 250 Hz to 320 Hz.

13. The muffler of claim 11, wherein acoustic interaction of the second acoustic device with the first acoustic device reduces an attenuation of sound emission by the first acoustic device in the first targeted frequency range compared to an attenuation of sound emission by the first acoustic device in the first targeted frequency range with the second acoustic device being omitted from the muffler.

14. The muffler of claim 11, wherein the second acoustic device is configured to attenuate sound emissions of a single order in the second targeted frequency range by at least 5dB.

15. The muffler of claim 14, wherein the single order is an order of 3.0.

16. The muffler of claim 11, wherein the first acoustic device is a Helmholtz resonator.

17. The muffler of claim 16, further comprising:
a wall disposed in the shell; and
a chamber defined in the shell on a first side of the wall,
the inlet and the outlet fluidly communicating with the chamber;
wherein:
the Helmholtz resonator is defined in the shell on a second side of the wall;
the second acoustic device is a perforated baffle disposed in the wall; and
the perforated baffle fluidly communicates the chamber with the Helmholtz resonator.

18. The muffler of claim 17, wherein the chamber fluidly communicates with the Helmholtz resonator only via perforations defined in the perforated baffle.

19. The muffler of claim 17, wherein:
the wall defines a neck of the Helmholtz resonator; and
the perforated baffle is disposed in the neck.

20. The muffler of claim 17, wherein:
the wall is a first wall;
the chamber is a first chamber;
the muffler further comprises:
a second wall disposed in the shell, the second wall defining a passage; and
a second chamber defined in the shell on a first side of the second wall;
the first chamber being defined between the first side of the first wall and a second side of the second wall;
the inlet fluidly communicates with the second chamber; and
the passage fluidly communicates the second chamber with the first chamber.
